(19) United States
(12) Patent Application Publication
(10) Pub. No.: US 2018/0311993 A1
(43) Pub. Date: Nov. 1, 2018

(54) PERSONAL NOTE ORGANISER WITH INDEX TABS

(71) Applicant: R9 Limited, Thursley, Godalming, Surrey (GB)

(72) Inventor: Jeremy Arthur HORWOOD, Thursley, Godalming (GB)

(73) Assignee: R9 Limited, Thursley, Godalming, Surrey (GB)

(21) Appl. No.: 15/779,387

(22) PCT Filed: Nov. 25, 2016
(86) PCT No.: PCT/GB2016/053715

§ 371 Date: May 25, 2018

(30) Foreign Application Priority Data
Nov. 27, 2015 (GB) 1520969.5
Jul. 13, 2016 (GB) 1612196.4

(51) Int. Cl. B42F 21/02; B42D 1/00

(52) U.S. Cl. CPC B42F 21/02; B42P 2221/04; B42D 1/003

(57) ABSTRACT

A personal note organiser comprises a plurality of sheets of which some or all of the sheets include an index tab. The index tabs are arranged such that a first strip of index tabs is arranged along at least a first and second edge of the plurality of sheets. At least a second strip of index tabs is arranged beside the first strip of index tabs. The second strip of index tabs is arranged along a first portion of the plurality of sheets beside the first edge, and along a second portion of the plurality of sheets beside the second edge.

This invention relates to a personal note organiser such as a notebook. This invention relates in particular to an arrangement of indexing tabs in a personal note organiser.

According to one aspect of the invention, there is provided a personal note organiser comprising a plurality of sheets with some or all sheets comprising an index tab, wherein the index tabs are arranged such that a first strip of index tabs is arranged along at least a first and second edge of the plurality of sheets; and at least a second strip of index tabs is arranged beside the first strip of index tabs; and the second strip of index tabs is arranged along a first portion of the plurality of sheets beside the first edge, and along a second portion of the plurality of sheets beside the second edge.

By arranging index tabs along at least two edges of a sheet, with a second strip arranged beside a first strip, a great number of index tabs can be provided while enabling viewing of all the index tabs at once. This can also enable indexing of a large number of sheets, as is useful in a personal note organiser. This can also enable the index tabs to be of relatively large size to enable handwritten labelling of the index tabs. A strip may be arranged along at least a first and second edge for example in an L-shape, C-shape, or in a curved shape. The personal note organiser is preferably for receiving handwritten information. The index tabs are preferably for receiving handwritten information.

For increasing the number of index tabs the first strip of index tabs may be arranged along a first, second and third edge of the plurality of sheets. The second strip of index tabs may be arranged along a first, second and third portion of the plurality of sheets. The first strip of index tabs may be arranged along a top, side and bottom edge of the plurality of sheets. The second strip of index tabs may be arranged along a top, side and bottom portion of the plurality of sheets.

The first and second strips may be substantially co-planar. The first and second strips are preferably visible in a plan view of the plurality of sheets in an intended sequence.

For increasing the number of index tabs a third strip of index tabs may be arranged beside the second strip of index tabs. For increasing the number of index tabs one or more further strips of index tabs may be arranged beside the third strip of index tabs.

For ease of labelling the area of each index tab may be between 50 mm² and 1000 mm², and preferably between 100 mm² and 750 mm², and preferably between 200 mm² and 400 mm², and preferably approximately 300 mm².

A first group of sheets in an intended sequence of sheets may comprise index tabs forming an innermost strip of index tabs. This can enable minimisation or avoidance of noting areas with shapes that are inconvenient for noting on.

Preferably neighbouring index tabs belong to successive sheets in an intended sequence of sheets. This can enable easy recognition of sheets containing common subject matter. Preferably neighbouring index tabs in a strip belong to successive sheets in an intended sequence of sheets.

A first sheet in an intended sequence of sheets may comprise a minimum noting area and an index tab, and each subsequent sheet in the intended sequence of sheets may comprise a noting area that corresponds to the area covered by a preceding sheet in the intended sequence of sheets. This can enable under-lying sheets to have a larger noting area than above-lying sheets. Maximisation of the noting area while providing index tab visibility can be enabled. This can also enable an index tab to be supported from below by under-lying sheets.

In an intended sequence of sheets each tab may be supported by underlying sheets. This may prevent subjecting a tab to torque if a force is applied to the tab, in particular in the course of writing on the tab. A last tab may be an exception, and may be supported otherwise. A first sheet in an intended sequence of sheets may have a first sheet area, and each subsequent sheet in the intended sequence of sheets may have an area at least as great as the area of the preceding sheet. This can enable an index tab located on a sheet to be supported from below by under-lying sheets (whether or not a noting area corresponds to the area covered by a preceding sheet) for ease of writing on an index tab. Each sheet in an intended sequence of sheets may have an area at least as great as the area of a preceding sheet in the intended sequence of sheets. A sheet in an intended sequence of sheets may have the area of a (or the) preceding sheet plus the area of an index tab. This can enable each tab to be supported by underlying sheets. Because the strips of tabs are arranged beside one another and because underlying sheets have greater sheet areas, upper tabs can be supported from beneath. This can enable avoiding overhanging sets of tabs where inferior support from beneath is provided to the tabs. An intended sequence of sheets may be from a smallest and/or topmost and/or first sheet to a largest and/or bottommost and/or last sheet.

For cross-referencing each index tab optionally comprises an identifier. For convenient cross-referencing each index tab optionally comprises a reference field for referencing an identifier. Each index tab may comprise an annotation field for characterising an indexed notation. The annotation field may comprise a date field and/or a content description field.

According to another aspect of the invention, there is provided a plurality of sheets for use with a personal note organiser as aforementioned.

According to another aspect of the invention, there is provided a personal note organiser substantially as herein described and/or as illustrated with reference to the accompanying drawings. According to another aspect of the invention, there is provided a plurality of sheets for a personal note organiser substantially as herein described and/or as illustrated with reference to the accompanying figures.

The invention extends to methods and/or apparatus substantially as herein described and/or as illustrated with reference to the accompanying drawings.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

These and other aspects of the present invention will become apparent from the following exemplary embodiments that are described with reference to the accompanying drawings, in which:

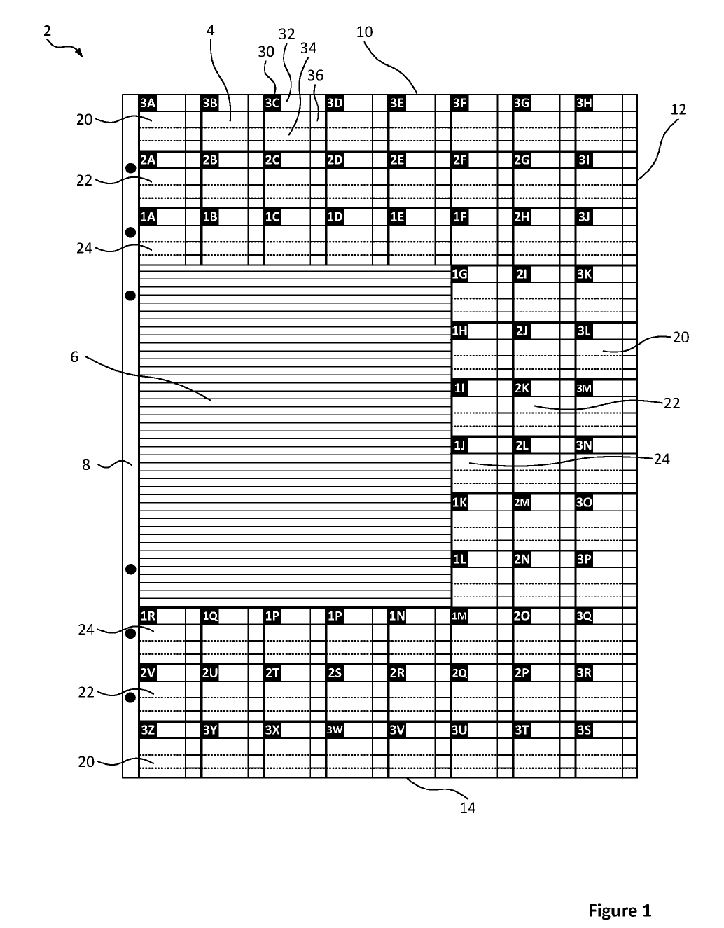

FIG. 1 shows a schematic of a personal note organiser with index tabs;

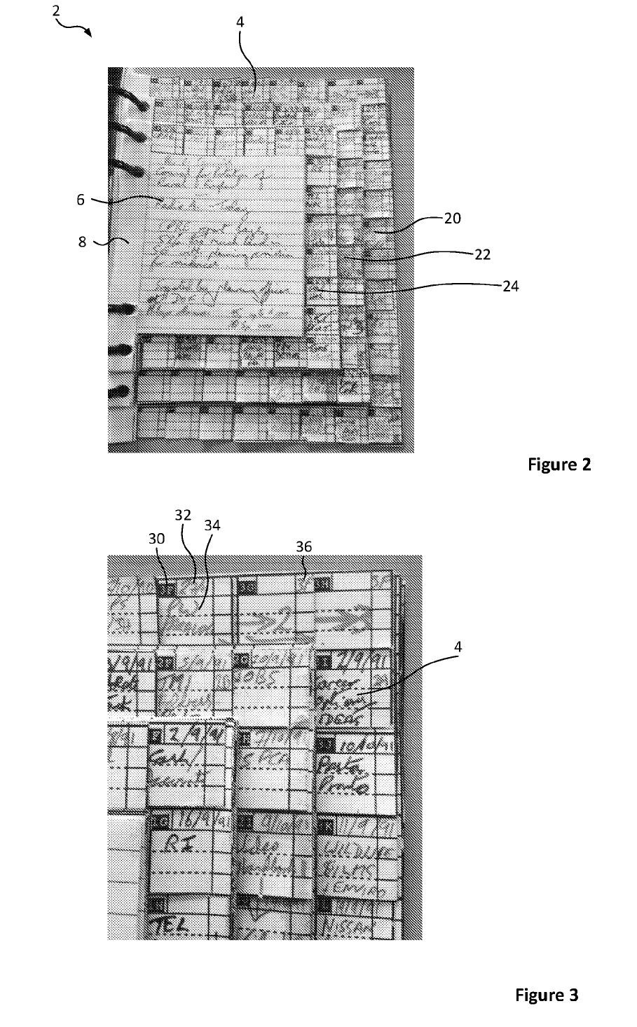

FIG. 2 shows a photograph of a personal note organiser with index tabs;

FIG. 3 shows an enlarged portion of the photograph of FIG. 2;

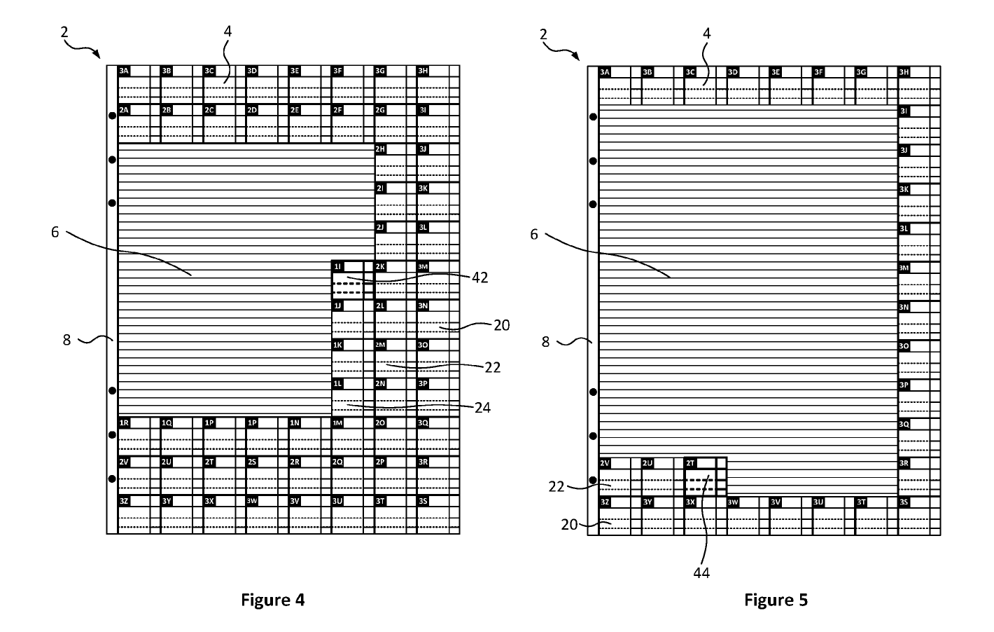

FIG. 4 shows a schematic of the personal note organiser of FIG. 1 open at a first page;

FIG. 5 shows a schematic of the personal note organiser of FIG. 1 open at a second page;

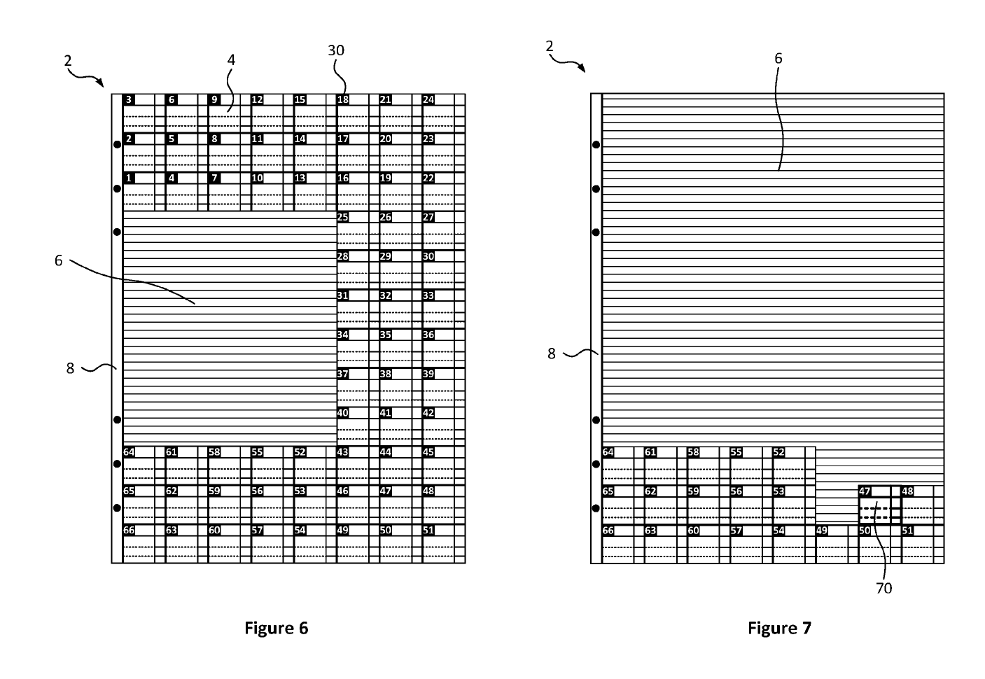

FIG. 6 shows a schematic of a further personal note organiser with index tabs;

FIG. 7 shows a schematic of the personal note organiser of FIG. 6 open at a first page;

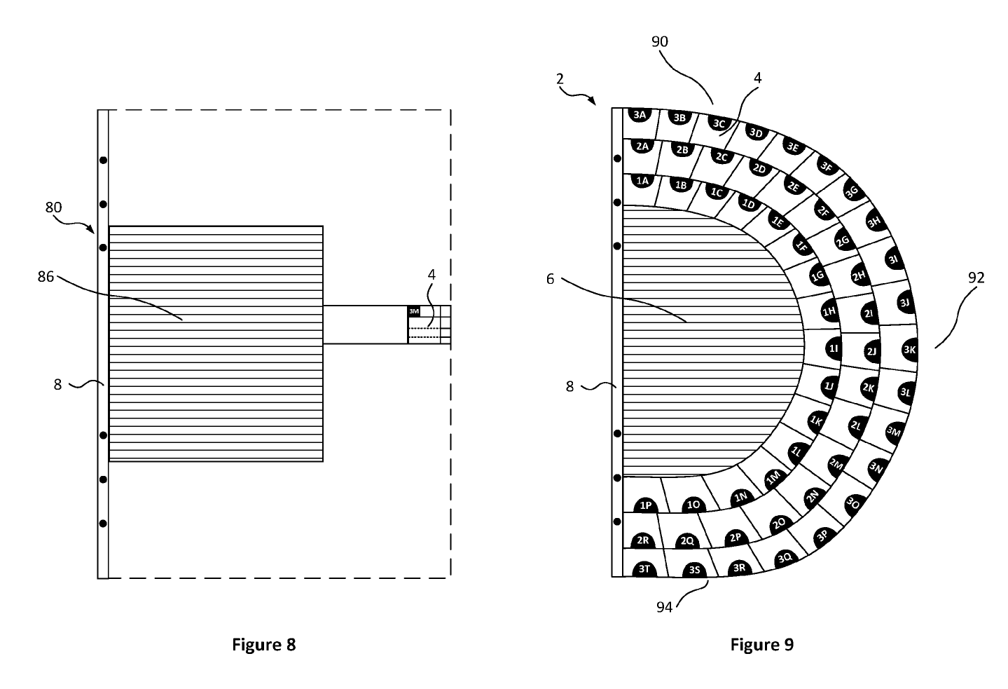

FIG. 8 shows a schematic of a single sheet for a further personal note organiser with index tabs; and

FIG. 9 shows a schematic of a further personal note organiser with index tabs.

FIGS. 1 and 2 show a personal note organiser 2 with index tabs 4 along three sides of a notebook. FIG. 3 shows an enlarged view of the top right hand corner of the notebook with an array of index tabs 4. The personal note organiser 2 is a notebook with index tabs 4 for pages to enable easy viewing and identification of what each indexed page contains, and selection of a desired indexed page. The index tabs 4 are designed to be sufficiently sized so that headings, dates and other identifiers may be handwritten on each index tab 4 to indicate what information the corresponding page contains.

Conventionally tabs are arranged along only one side of a block of sheets. To be large enough to receive handwritten identifiers only relatively few tabs are typically included. The larger each tab is made in order to provide space for a reasonable amount of information to define the contents of the corresponding page the fewer the number of pages that can be indexed. In the example illustrated in FIG. 1 there are twelve index tabs (marked 3H to 3S) arranged along the right hand edge 12 (opposite the bound edge) of A5 sized sheets, each index tab being sufficiently large for hand labelling. If only twelve index tabs are presented to the user only twelve pages can be indexed, making for either a very short notebook or a number of pages that are combined together under the same index. For a notebook, where a variety of subject matter can be covered in close sequence and with limited semantic relationship between the subject matter on different pages, having one index tab for a number of pages may be unsatisfactory. In order to accommodate larger numbers of tabs, sometimes tabs on identically sized sheets of paper are arranged in tiers, with an upper group of tabs obscuring a lower group of tabs. Since the upper tier of pages are the same size as lower tiers, this prevents a user from observing all index tabs simultaneously, and requires the use of a table of content in order to identify the desired indexed page. For handwritten notes compiling a table of content is laborious and inconvenient.

The personal note organiser 2 in FIG. 1 presents index tabs 4 along the three unbound sides of a notebook. Instead of arranging index tabs 4 along just one edge 12 of the sheets, index tabs are arranged also along the top edge 10 and bottom edge 14 of the sheets. In the example illustrated in FIG. 1 there is a strip 20 of twenty-six index tabs (marked 3A to 3Z) arranged along the top edge 10, right edge 12 and bottom edge 14 of A5 sized sheets (compared to the twelve index tabs along the right edge 12 only).

The personal note organiser 2 further presents index tabs in two-dimensional arrays toward the centre of the sheets. In the example illustrated in FIG. 1 there are two further strips 22 24 (marked 2A to 2V and 1A to 1R) of index tabs 4 arranged concentrically to the outmost strip 20 of index tabs along the edges of the sheets. In order to accommodate the inner strip 24 of index tabs the upper layers of sheets have a smaller noting area 6. The use of additional strips 22 24 of index tabs on three sides (top, right and bottom) provides twenty-two further index tabs in the middle strip 22 (marked 2A to 2V) and eighteen further index tabs in the innermost strip 24 (marked 1A to 1R). In the example illustrated in FIG. 1 a total of sixty-six index tabs 4 are provided, enabling indexing of sixty-six pages, with an area of 17.5 mm by 17.5 mm for each index tab 4 and a minimum noting area 6 of 87.5 mm by 105 mm and a binding area 8 of 8 mm width. All index tabs 4 can be viewed from the first page view as seen in FIGS. 1 and 2. By arranging the index tabs 4 of the different strips 20 22 24 adjacent one another the index tabs 4 of all underlying pages can be viewed at once; when the top page is viewed all available index tabs are visible.

Depending on the notebook size, more or fewer similarly sized index tabs can be accommodated than in the example illustrated in FIGS. 1 and 2. An A4 sheet set for example can accommodate six strips of index tabs of 17.5 mm by 17.5 mm each and arranged side by side and concentrically around the top, side and bottom of the sheets, while still providing a reasonable minimum noting area. In an example for an A4 notebook forty index tabs are in the outermost strip (twelve at the top edge, sixteen at the side edge and twelve at the bottom edge); the adjacent more inward-lying strip has thirty-six index tabs (with the noting area of the corresponding pages being smaller in order to reveal the index tabs of the pages underneath) followed by strips with thirty-two, twenty-eight and twenty-four index tabs; and the innermost strip has twenty index tabs. The total number of individually and uniquely indexed pages in this example is one hundred and eighty (compared to conventionally just eighteen visible index tabs at only the right edge 14).

The number of index tabs that can be accommodated in a notebook of a particular size is dependent on the minimum noting area and the desired index tab size. If smaller index tabs are acceptable then more index tabs can be fitted into the same area. If a smaller minimum noting area is acceptable then a greater area can be used to accommodate index tabs, permitting a greater number of index tabs and additional tiers. The examples illustrated above have index tabs of 17.5 mm by 17.5 mm each (having an area of 306.25 mm²) and a minimum noting area of 87.5 mm by 105 mm, which provides an acceptable balance. In another example index tabs are 15 mm by 15 mm each (having an area of 225 mm²) and the minimum noting area is 105 mm by 130 mm; in this example a notebook that is slightly larger than A5 can accommodate 87 index tabs in three strips along three edges.

To assist indexation and fast identification in the illustrated examples each index tabs had a printed identifier 30. In the example illustrated in FIGS. 1 to 3 each index tab includes a unique page identifier 30 that codifies the strip 20 22 24 (innermost strip: 1; middle start: 2; outer strip: 3) and the depth within a strip-group (top of a strip-group: A; lower pages: B, C, etc.). Each index tab further includes a space for a date 32, a space for a title or content description 34 and a space for referencing 36 to another note page.

FIGS. 4 and 5 show the personal note organiser 2 of FIGS. 1 and 2 opened at different pages. In FIG. 4 a page indexed by an index tab 42 in the inner strip 24 with unique page identifier ‘1I’ is shown. The noting area 6 is larger for this page than for the topmost page as shown in FIG. 1, as the area lying beneath the index tabs of preceding pages can be used for noting in addition to the minimum noting area. In FIG. 5 a page indexed by an index tab 44 in the middle tier 22 with unique page identifier ‘2T’ is shown. The noting area 6 of the page shown in FIG. 5 is larger than the noting area 6 of the page shown in FIG. 4. As is evident from FIGS. 4 and 5, for a specific index tab the underlying sheets provide a noting area beneath that tab. This provides support from beneath to the index tab, as is beneficial for the user to be able to (manually) write on the index tab. The support is provided where underlying sheets extend beneath an index tab, evidently whether the noting area of underlying sheets extends beneath the index tab or not.

FIG. 6 shows an alternative index tab arrangement for a personal note organiser 2 where the indexing tabs 4 of successive pages are not generally in the same strip 20 22 24. Instead the index tabs 4 are arranged such that pages that are close to one another have index tabs close to one another. The unique identifiers 30 codify a sequential page number. FIG. 7 shows the personal note organiser 2 of FIG. 6 opened at a page indexed by an index tab 70 in the middle strip 22 with unique page identifier ‘47’. The noting area 6 is larger for the page shown in FIG. 7 than for the topmost page as shown in FIG. 6, as the area lying beneath the index tabs of preceding pages is obscured from view until opened at that page and can therefore be used for noting in addition to the minimum noting area. Equally the noting area of that page does not obscure from view any subsequent index tabs in the sequence.

The sheets of the personal note organiser may be loose leaf sheets that are bound together in a binder as in the example illustrated in FIG. 2. Alternatively the sheets may be bound together by other means, or may be provided loose for a user to insert into a binder. Each index tab may index a single page or a number of pages collectively. If sheets are used on both front and back then each index tab may refer to one sheet or two pages, either on the same sheet, or facing one another on adjacent sheets.

In an alternative personal note organiser to the examples described above the noting area is same for all sheets, and the index tabs protrude from the edge of the noting area in a variety of directions and distances to form an array of index tabs similar as can be seen in FIG. 1. FIG. 8 shows an example of an individual sheet 80 according to this variant of the personal note organiser, with a noting area 86 that is same for all sheets and the index tab 4 for that sheet 80 on a protrusion. The illustrated sheet 80 is with a tab 4 in the outermost strip 20 at the right edge 12 of the personal note organiser. The A5 area covered by all the sheets collectively is indicated in FIG. 8 by the dashed rectangle.

The noting area for most sheets of the example illustrated in FIG. 8 is smaller than the noting area of the corresponding sheets of the examples illustrated in FIGS. 1 to 5, as well as the examples illustrated in FIGS. 6 and 7. Also, because the noting area 86 in the example illustrated in FIG. 8 is limited to a common area for all sheets and does not extend to areas that are covered by overlying tabs (unlike the examples illustrated in FIGS. 1 to 7), the noting area of underlying sheets does not provide a support beneath the writing area of the tabs 4. By contrast in the examples illustrated in FIGS. 1 to 7 the noting area 86 of each sheet extends such that at an index tab 4 a sheet is supported by the sheets beneath it. By virtue of the underlying support a user can more conveniently write on an index tab than if it is unsupported from below and is suspended in mid-air.

In a variant the sheets of the personal note organiser are not rectangular as in the examples illustrated above, but with for example rounded corners or having an arbitrary shape along the non-bound edges. The index tabs may be arranged in other arrangements than in the rectangular array in the examples illustrated above.

FIG. 9 shows an example of the personal note organiser 2 with semi-circular sheets. Here the top portion 90 of a sheet takes the place of the top edge 10 of a rectangular sheet (and the side portion 92 of a sheet takes the place of the side edge 12 of a rectangular sheet, and the bottom portion 94 of a sheet takes the place of the bottom edge 14 of a rectangular sheet). The index tabs 4 are arranged in a polar grid.

In a variant the sheets are bound at the right edge and index tabs are arranged along the top, left and bottom sides of the sheets.

The arrangement with the index tabs arranged in a number of strips along a number of edges of the sheets, as illustrated in FIGS. 1 to 9, is particularly useful for a personal note organiser intended to receive handwritten notes in the noting area and to receive handwritten annotations in the index tabs. If the same number of index tabs (of a size large enough to be useful for handwriting) were arranged along only one edge of the sheets in a number of tiers, then for the uppermost sheets the noting area would be narrow and tall. For the purpose of writing notes such a narrow format of noting area is inconvenient, as it forces the user to start a new line often, which is cumbersome both for writing and reading. If the same number of index tabs (to permit adequate indexing) were arranged around the edges of the sheets in a single tier, then the area of each index tab would be too small for convenient handwriting of annotations. Index tab arrangements where layers of index tabs lie over one another, with an upper index tab obscuring an underlying index tab, do not provide ease of access to the index information of all index tabs at the same time; also, in this arrangement some index tabs may be suspended in mid-air and unsupported from below, which is inconvenient for making handwritten entries on an index tab. The arrangement with the index tabs arranged in a number of strips along a number of edges of the sheets, as illustrated in FIGS. 1 to 9, is particularly favourable for a personal note organiser because index tabs can be large enough and sufficiently supported from beneath to receive handwritten annotations, while providing a sufficient number of easily viewed index tabs for meaningful indexing.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in any claims are by way of illustration only and shall have no limiting effect on the scope of the claims.

1. A personal note organiser in the form of a notebook for receiving handwritten information, the notebook comprising a plurality of sheets of which some or all of the sheets include an index tab, and wherein:
the index tabs are arranged such that a first strip of index tabs is arranged along at least a first and second edge of the plurality of sheets; and
at least a second strip of index tabs is arranged beside the first strip of index tabs;
the second strip of index tabs is arranged along a first portion of the plurality of sheets beside the first edge, and along a second portion of the plurality of sheets beside the second edge; and
the index tabs are for receiving handwritten information, with the area of each index tab being between 100 mm² and 750 mm².

2-21. (canceled)
